(19) United States
(12) Patent Application Publication
(10) Pub. No.: US 2021/0150412 A1
(43) Pub. Date: May 20, 2021

(54) SYSTEMS AND METHODS FOR AUTOMATED MACHINE LEARNING

(71) Applicant: The Regents of the University of California, Oakland, CA (US)

(72) Inventors: Hooman H. Rashidi, Davis, CA (US); Samer Albahra, Davis, CA (US); Nam Tran, Davis, CA (US)

(73) Assignee: The Regents of the University of California, Oakland, CA (US)

(21) Appl. No.: 17/100,082

(22) Filed: Nov. 20, 2020

Related U.S. Application Data
(60) Provisional application No. 62/938,047, filed on Nov. 20, 2019.

(51) Int. Cl. G06N 20/00; G06N 3/08

(52) U.S. Cl. CPC G06N 20/00; G06N 3/08

(57) ABSTRACT

In some aspects, the disclosure is directed to methods and systems for automatic machine learning through a combination of unsupervised and supervised machine learning from a large set of machine learning algorithms and feature selectors and transformers to generate a plurality of machine learning models, each associated with a particular combination of features and hyperparameters. Each machine learning model is trained and assessed to identify the best performing model based on one or more specified statistical measures. An application may be automatically constructed based on a selected model to process further input data.

### RELATED APPLICATIONS

This application claims the benefit of and priority to U.S. Provisional Application No. 62/938,047, entitled “Systems and Methods for Automated Machine Learning,” filed Nov. 20, 2019, which is incorporated in its entirety herein.

### FIELD OF THE DISCLOSURE

This disclosure generally relates to systems and methods for machine learning and artificial intelligence. In particular, this disclosure relates to systems and methods for automatic generation and identification of optimized machine learning models and applications.

### BACKGROUND OF THE DISCLOSURE

Machine learning techniques allow for classification and probabilistic estimation or prediction of various results based on input data, and can utilize different techniques and algorithms, such as neural networks, support vector machines, Bayesian networks, etc. While these systems can efficiently create a predictive model from a selection of input data and model parameters, the choice of such input data and parameters and even the underlying model or algorithm is up to the user or data scientist creating the machine learning system, using subjective guesses or hunches, or relying on their own experience for initial parameters and selections. For example, a data scientist most familiar with neural networks may select to use a neural network for setting up a new machine learning system, regardless of whether such a system is optimal for the particular input data and desired outputs. The scientist may manually and laboriously try different parameters (e.g. number of hidden layers, learning rate, etc.) for the network, retrain the system, and compare test outputs to determine whether a first parameter value yields more desirable results than another parameter. Typically, due to limitations in time and other resources, the resulting system will be left with parameters judged “good enough”. However, other parameter values—and indeed, other machine learning models and combinations of input data—may provide better results, but such values and models may never be discovered or even attempted by the scientist.

Furthermore, setting up such machine learning systems requires significant knowledge and expertise due to the required subjective guesses. Users lacking such knowledge and expertise may be entirely lost, essentially selecting values at random. Given the potentially tens or hundreds of thousands or millions of combinations of models, hyperparameters, and input data, building an optimized machine learning system is impossible for most users, and at best, is only nearly impossible for the most experienced, highly-skilled programmers.

### BRIEF DESCRIPTION OF THE DRAWINGS

The patent or application file contains at least one drawing executed in color. Copies of this patent or patent application publication with color drawings will be provided by the Office upon request and payment of the necessary fee.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a logical diagram of an implementation of a system for automatic machine learning;

FIG. 2 is a block diagram of an implementation of a system for generation of machine learning models;

FIG. 3 is a flow chart of an implementation of a method for automatic machine learning;

FIGS. 4A-4J are screenshots of an implementation of a user interface for automatic machine learning;

FIG. 5 is a screenshot of an implementation of an automatically generated machine learning application; and

FIGS. 6A and 6B are block diagrams depicting embodiments of computing devices useful in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for automatic machine learning; and
Section B describes a computing environment which may be useful for practicing embodiments described herein.

### A. Systems and Methods for Automatic Machine Learning

The systems and methods discussed herein provide implementations of an automatic system for generating machine learning systems and applications, without requiring subjective guesses of the user, and without requiring any knowledge of machine learning. Implementations of the system and methods, and the machine learning (ML) systems and web applications generated from them, may be used in any context, on any type of data, as the system automatically finds optimized combinations of models, hyperparameters, and feature sets for the input data and desired output characteristics. Such optimized machine learning systems may be used with medical diagnostic systems, natural language processing, computer vision systems, cryptographic analysis, or any other technology in which probabilistic classification or data processing may be useful.

In brief overview, the automatic machine learning generation system, referred to herein as a machine intelligence learning optimizer or “MILO”, evaluates multiple unique algorithm and feature set combinations to allow each dataset to find it's optimal ML model (optimal being used herein to mean the best algorithm, the best feature set or transformed features, the best scaling requirements, or the best scoring parameter, or a combination of some or all of these) rather than trying to fit a predetermined algorithm and feature set selected by a user to a given dataset. The approach in MILO makes no assumptions about the data and allows the automatic machine learning (auto-ML) platform to build a very large number of ML models through several of our novel embedded tools (e.g. our custom combination of grid and random search along with our custom combination of feature selectors and transformers) that can ultimately find the best solution for one's given task. Through this approach one may also find “the needle in the hay stack” in contrast to the traditional human-driven approach which is incapable of building and evaluating the very large number of ML models that are being assessed through MILO for each given unique dataset/task. The evaluation can be performed in parallel for each combination, allowing easy scalability by multi-computer or multi-processor systems. Each combination is used to train a model that is then tested for accuracy, sensitivity, or other characteristics, and ranked or scored accordingly based on the user's needs. Following the identification of the most optimal model for a given task, an application is then automatically generated which can then be used for subsequent data processing, without requiring any coding knowledge by the user. Thus, implementations of these systems and methods not only improve accessibility and feasibility of machine-learning based data analysis, but also help identify the optimal machine learning model for each given task in a user-friendly approach.

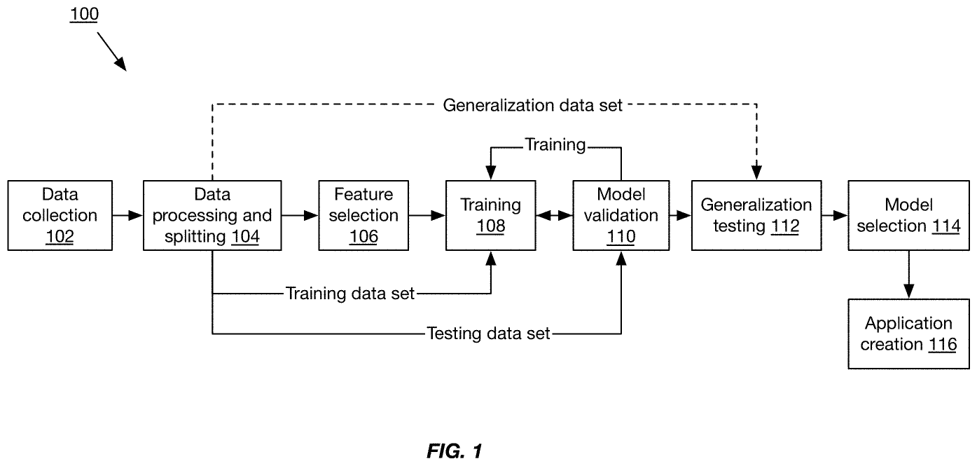

FIG. 1 is a logical diagram of an implementation of a system 100 for automatic machine learning. At step 102, the system may collect data for processing and analysis. The data may be in any suitable format or type (e.g. database, array, flat file, concatenated file, etc.), and may comprise balanced data (e.g. having an equal proportion of positive and negative outcomes or classifications) which may be used for training and initial validation of the generated ML models; and, thereafter an unbalanced data (e.g. having an unequal proportion of positive and negative outcomes or classifications to represent the true prevalence of the query) to assess the generalization of each of the ML models.

At step 104, the system may pre-process or normalize the input data. In many implementations, input data may be incomplete for various values, due to differences in data collection: given data with values for features or entities a, b, c, d, and e, some entries retrieved from a first source may be lacking values for an entity or feature a, while some entries retrieved from a second source may be lacking values for a feature b. For example, for a machine vision system, a first collection of data may include pixel bitmaps and gyroscopic orientation data of a camera, while a second collection of data may include depth maps or pixel clouds from a stereoscopic camera but lack gyroscopic orientation data. In some implementations, entries lacking data values may be removed or filtered from input data (e.g. removing rows corresponding to such entries from an array in which columns correspond to each feature value, in some implementations). In other implementations, if a large proportion of the input data is lacking a data value for a specific feature, data corresponding to that feature may be disregarded (e.g. removing columns corresponding to the feature in implementations as discussed above). The removal of rows (e.g. entries) and/or columns (e.g. feature values) may be configured by a user during setup, and/or threshold levels for missing data may be set by the user (removing a column when corresponding data for >75% of the entries is absent, for example). Accordingly, missing values may be removed such that the filtered or cleaned input data is complete for each entry. In other implementations, artificial values may be inserted in place of missing data (e.g. based on an average of other values for the feature, or other such methods), though this may end up suggesting false correlations or reducing classification accuracy.

Step 104 may also include scaling of the data, in some implementations. For example, in many implementations, data values for different features may fall in very different ranges (e.g. 0-1 for a first feature, and 0-1000 for a second feature). Utilizing the data without scaling may result in the data for such latter features having increased influence in the resulting classification (e.g. over- or under-fitting of classification results), even though this may not accurately represent the real influence of each feature. Accordingly, in some implementations, the data may be scaled via any suitable scaling algorithm (e.g. a standard scaler, scaling the data based on a calculated mean and standard deviation; a MinMax scaler, shrinking the data range to predetermined limits; a normalization scaler to a predetermined limit, etc.). In some implementations, multiple scalers may be used to generate multiple scaled data sets for subsequent analysis and processing (for example, because some scalers may result in a more optimized model than others, for some feature sets). Similarly, in some implementations, the unscaled data may also be used for subsequent analysis and processing (for example, for some feature sets, a tree-based algorithm such as random forest may work better with unscaled data).

Step 104 may also include splitting the data into a plurality of subsets for training and validation. For example, in many implementations, a balanced data set may be divided into a first subset for training purposes, and a second subset for validation purposes. In some implementations, balanced data may be explicitly provided, while in other implementations, the system may select a balanced subset of data from input data (e.g. a subset having approximately equal proportions for each classification result). Dividing or splitting the balanced data set may be performed randomly in some implementations, in order (e.g. the first half of entries in the data set), or in a combination of ordered and random (e.g. shuffled splits, random clusters, etc.). The first subset of data used for training purposes may be of any predetermined size or percentage of the balanced input data (e.g. 10%, 20%, 30% of the data, or any other such value). In some implementations, the data may be split prior to scaling, while in other implementations, the data may be scaled prior to splitting.

At step 106, the system may identify features or sets of features via an unsupervised machine learning process (e.g. Analysis of Variance (ANOVA) F-value, Random Forest importances, etc. or combinations of these or other unsupervised processes) and transformed via principal component analysis or a similar algorithm to feature correlations and covariances. For example, combinations of features may be ranked by correlation, and the top n % of the combinations may be utilized for further analysis (e.g. top 90% of PCA or top 50% of F-value select percentile). In some implementations, different feature selection processes may be performed in separate pipelines or for use by different models. This ensures that the resulting models are not only optimized by hyperparameters, but also feature selection (different feature sets may be used for each model, as independent subsets of the originally provided feature set within the input data). As discussed above, in machine learning systems not generated through implementations of the processes and systems provided herein, data scientists typically select feature sets or combinations of features based on subjective hunches, as it may be difficult or impossible for human users to determine how much each feature contributes to any particular correlation.

At step 108, models may be generated for each feature selection. Different models may be generated for each feature selection identified at step 106, and may utilize different supervised machine learning algorithms (e.g. neural network, logistic regression, naïve Bayes, K-nearest neighbor, support vector machine, gradient boosting machine, and random forest). Furthermore, for each combination of a given feature set and model type, models may be generated and trained with different hyperparameter values (e.g. different gamma and c values for support vector machines, etc.). To select or tune different hyperparameter values, in various implementations, one or more hyperparameter searchers may be utilized, including a custom grid search tool, and a custom random search tool. In some implementations, the grid search tool may generate models with different values for each hyperparameter distributed uniformly within a predetermined range (e.g. with values equivalent to points distributed on a uniform grid having axes corresponding to each hyperparameter). In some implementations, the random search tool may randomly select hyperparameters with values within the predetermined ranges. In a further implementation, the random hyperparameter selections may be further based on the uniform distribution determined via the grid search tool. In some implementations, additional hyperparameter searchers may be utilized, such as a Bayesian search. Accordingly, for a given feature selection, hundreds of models may be generated (e.g. two hundred hyperparameter values for each of seven supervised learning algorithms, or 700 models per feature selection, in some implementations); and hundreds of thousands of models may be generated in total (e.g. using the same numbers, 700 models per feature selection, 25 feature selection combinations, three different scaling processes for the input data (e.g. unscaled, MinMax, and standard scaling), and three different scoring calculations yielding >100,000 distinct models). At step 108, each model may be trained using the training subset of balanced data (e.g. first portion of balanced data discussed above), and at step 110, each model may be tested using the validation subset of balanced data (e.g. second portion of balanced data discussed above). In some implementations, at step 112, the models may also be tested against the generalization data set (e.g. unbalanced input data) to assess the true performance of the trained model on realistic data. At steps 110 and 112, each model may be scored on the validation and generalization data via a plurality of performance assessment techniques. For example, each model may be scored by accuracy, Area under the curve (AUC) receiver operating characteristics (ROC) curve, F1 score (e.g. based on precision and sensitivity), etc. As noted above, using these different scorers results in slightly different models during training phases 108, and ensures that an optimized model will be generated for the desired scoring characteristic. A reliability and calibration curve may also be calculated for each model, along with a Brier score (e.g. measuring accuracy).

Although shown as a single pipeline, as discussed above, these processes may be performed in parallel for each model, as each model is independent of the others. This makes scalability across a plurality of processors, machines, or virtual machines easy and efficient.

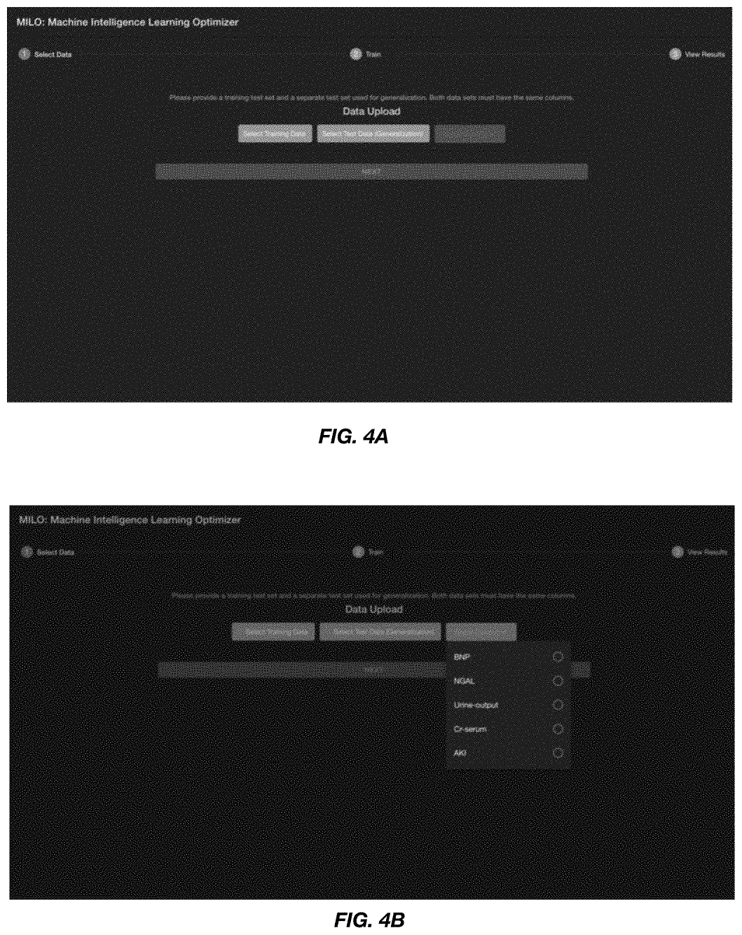

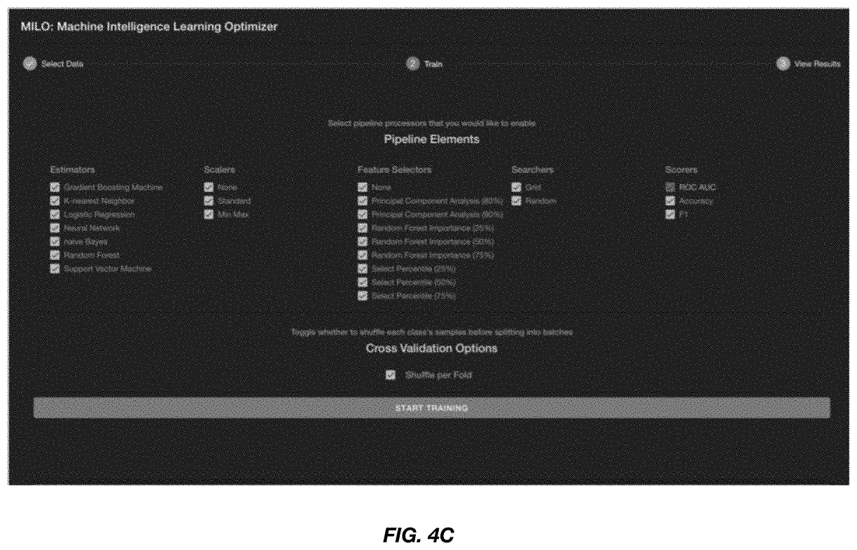

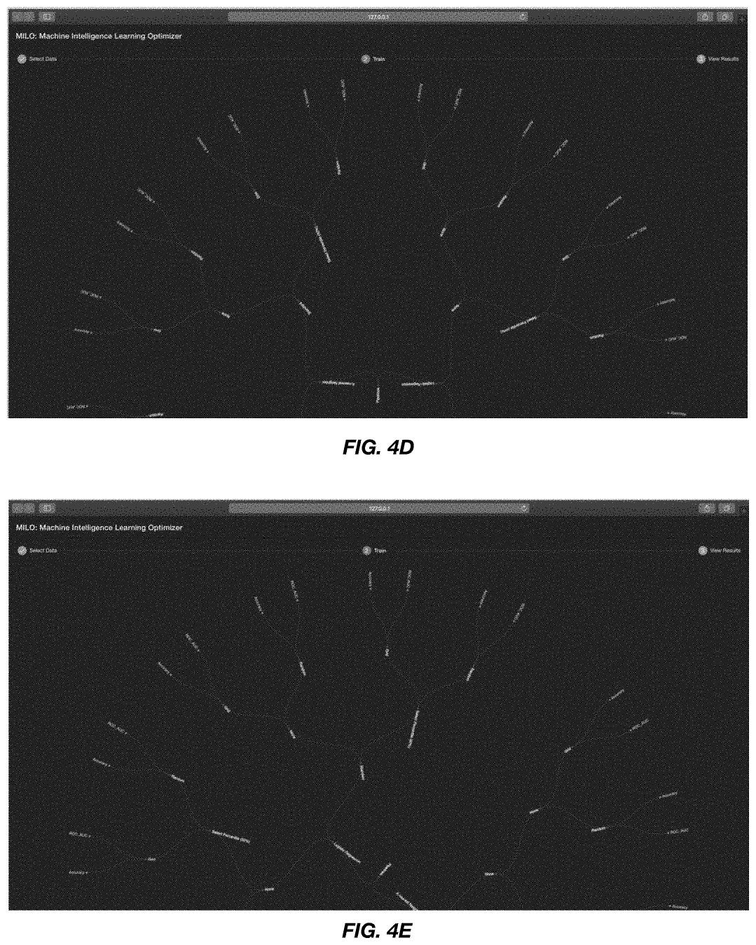

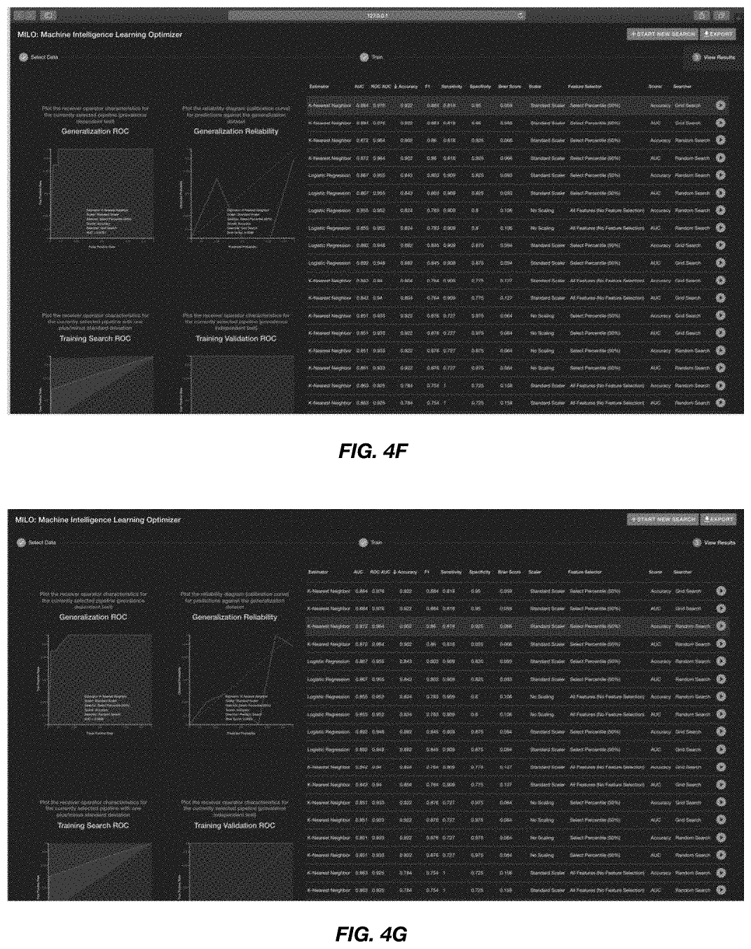

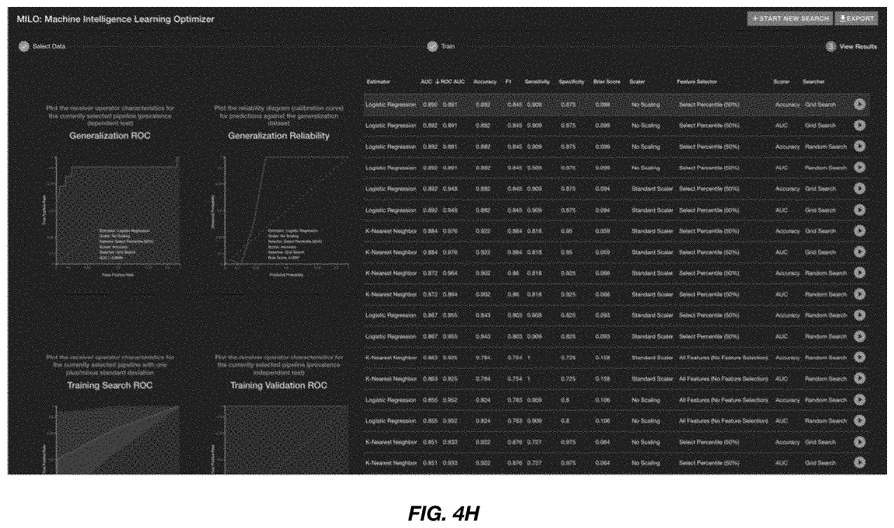

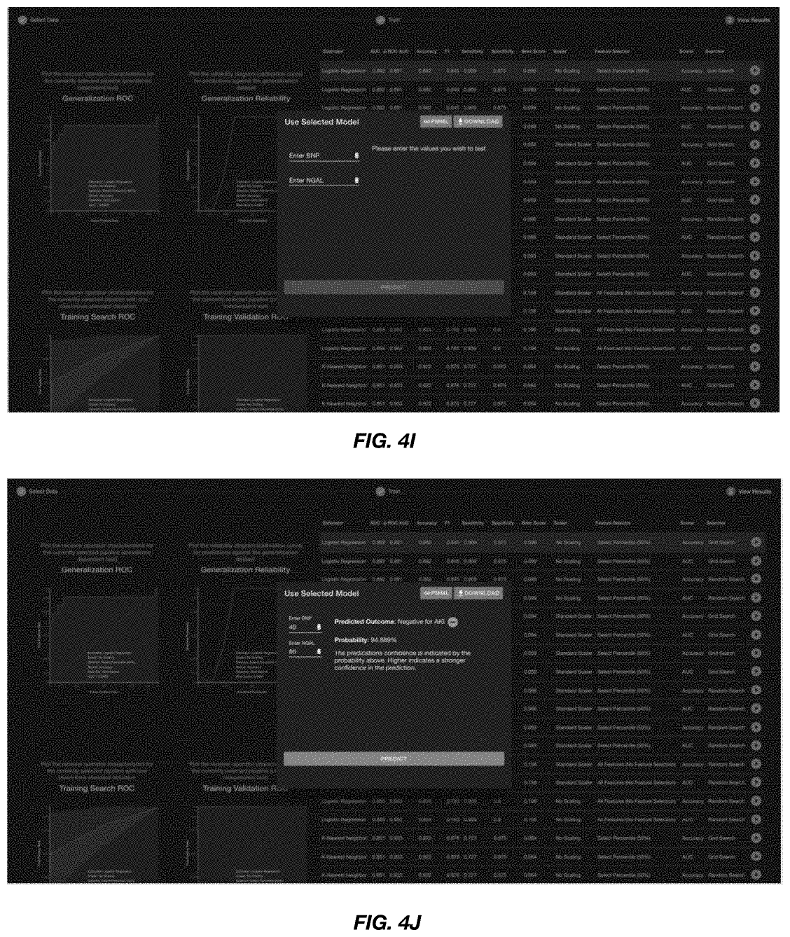

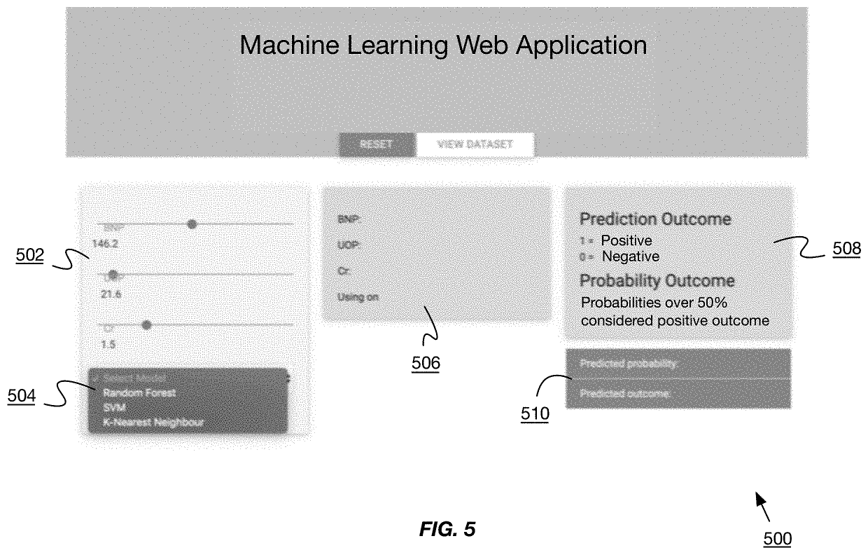

At step 114, the results of the model training and validation may be provided to the user as an ordered or ranked list, with the order corresponding to a selected scoring characteristic (e.g. accuracy, AUC ROC, etc.). The user may easily compare the results of different feature sets, model types, and hyperparameter tunings to identify an optimized model having the desired response characteristics. The results may be presented via any suitable visual interface, such as a web interface or web application as discussed below in connection with FIGS. 4A-4J. This allows a user with no programming experience to select the best or most optimal machine learning model for their task. In some implementations, the interface may also include a command to cause the system to generate a separate application (e.g. web application, standalone application, hosted application, etc.) for a selected model (e.g. feature selection, hyperparameter tuning, and model type) at step 116, as discussed below in connection with FIG. 5. This standalone application may execute the selected model on additional data input into the application, and may be used by users, researchers, scientists, and engineers with no machine learning experience or even coding experience.

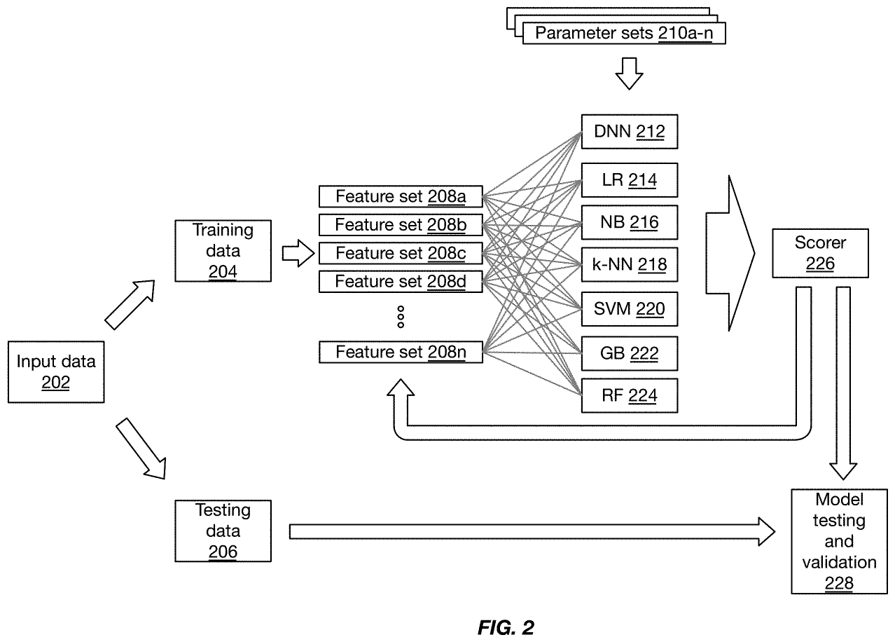

To further clarify the system's operation, FIG. 2 is a block diagram of the automatic machine learning system. As discussed above, input data 202 is split into training data 204 and testing data 206, e.g. via a randomized or semi-randomized selection process (in any division or ratio, such as 80% training data and 20% testing data). A number of feature sets 208a-208n selected via feature selectors and transformers (e.g. ANOVA F-statistic values, random forest feature importance values, PCA, etc.) may be generated from the input data or training data, and each used with a plurality of machine learning algorithms 212-224 (e.g. deep neural network 212; logistic regression 214; naïve Bayes 216; k-nearest neighbor 218; support vector machine 220; gradient boosting machine 222; and random forest 224) and parameter sets 210a-210n (e.g. coefficients or weights for the various models, including c values, gamma values, etc., for each ML algorithm) selected via a grid and random searches. Each model may be scored by one or more scorers 226 to optimize the model, and then tested with testing and/or generalization data 228.

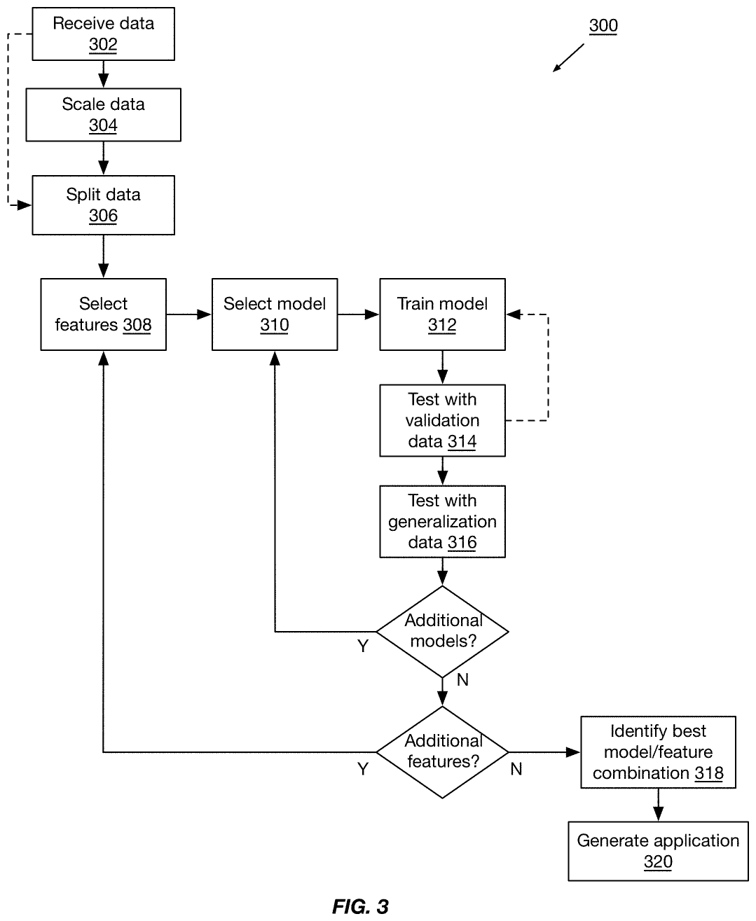

FIG. 3 is a flow chart of an implementation of a method 300 for automatic machine learning. At step 302, a system may receive data for analysis and generation of machine learning models. The data may be in any suitable format and may be balanced or unbalanced. At step 304, in some implementations, the data may be scaled or normalized via one or more scalers (e.g. MinMax, standard scaling, normalization, etc.). In some implementations, step 304 may be skipped or a copy of the input data may be left unscaled. Additionally, at step 304 in some implementations, missing data or data missing one or more values may be removed or filtered from the input data.

At step 306, the data may be split into training data, testing data, and in some implementations, generalization data. The training data and testing data may be balanced (e.g. having equal distributions of classifications) in many implementations, while the generalization data may be balanced or unbalanced.

At step 308, features for a model may be selected. The features may be a subset of features of the data, such as a combination of two or more features. In many implementations, features may be selected by identifying correlations and covariances between combinations of features, and selecting from the combinations of features having the highest covariances or correlations (e.g. the top 50% of combinations, or any other such value). At step 310, a model type and parameters (e.g. coefficients or weights, including c values, gamma values, etc.) may be selected. The parameters may be selected via a random search or grid search across a predetermined range of values for each parameter.

At step 312, the model may be trained with the training data, and at step 314, the model may be tested with the validation data and a score calculated. In some implementations, multiple iterations of training and validation may be performed (e.g. a predetermined number of iterations based on a user selection or configuration). At step 316, the model may be tested with generalization data not provided during the training process.

Steps 310-316 may be repeated for additional model types and parameter values, and steps 308-316 may be repeated for each additional feature set. Although shown as a serial process, in many implementations, steps 308-316 may be performed in parallel and distributed across different processors, threads, cores, machines, virtual machines, computation clusters, etc. Because each model is independent, training and validation for each model may be easily provided to different computing devices, e.g. by providing the input data and a model configuration (e.g. feature set, model type, and hyperparameters). The computing device may perform training and testing and calculate scores (e.g. sensitivity, accuracy, AUC ROC, etc.) and provide the scores to an aggregating device. The aggregating device may receive scores of each of the computing devices performing model training and analysis, and may aggregate the result in a table, array, or other data structure.

At step 318, the aggregated scores for each model may be sorted to identify a highest performing model (e.g. highest sensitivity, highest accuracy, etc., depending on the desired characteristics and use for the machine learning model). The scores may be presented via a user interface, such as the web application interface discussed below in connection with FIGS. 4A-4J.

At step 320, in some implementations, the system may generate a stand-alone application using a selected model (e.g. feature set, model type, and hyperparameter tuning) from the plurality of models identified in the aggregated scores (e.g. by selecting the corresponding model in the user interface). The model may be used to process additional input data, without requiring further training, adjustment, or tuning of the model.

FIGS. 4A-4J are screenshots of an implementation of a user interface for automatic machine learning. FIG. 4A illustrates an implementation of a data input interface through which a user may select training data and generalization data for use by the system (e.g. uploading the data from another computing device over a network, retrieving the data from local storage, etc.). The input data may be parsed and feature sets identified as discussed above. A desired classification type may be selected as shown in FIG. 4B (e.g. a classification identified in the input data).

FIG. 4C illustrates an implementation of a user interface for selecting or configuring pipeline processing of the machine learning models. As shown, various estimators or model types may be selected, as well as various scalers, feature selectors and transformers, hyperparameter searchers, and scorers. In the interface illustrated, one or more settings may be selected for each configuration option; the system will construct models according to combinations of each setting (e.g. using a first model type, first scaler, first feature selector, etc. for a first model; using a second model type, first scaler, first feature selector, etc. for a second model; using the first model type, a second scaler, and the first feature selector, etc. for a third model; etc. in every potential combination).

FIGS. 4D and 4E illustrate user interfaces representing trees of selected model configurations. For example, FIG. 4D illustrates a tree of models with models having a k-nearest neighbor type on the left and models having a logistic regression type on the right; k-nearest neighbor models using a standard scaler at the left (k-nearest neighbor models not using the standard scaler being offscreen in the example screenshot); k-nearest neighbor models using the standard scaler and a 50% select percentile feature selector at the top left; etc. The final leaf nodes of each tree thus represent each combination of configurations for a particular model.

FIGS. 4F-4H are screenshots illustrating implementations of user interfaces for reporting scores for each machine learning model, and for allowing the user to sort and select models for further use. As shown, in some implementations, each model may be identified by score characteristics (e.g. accuracy, sensitivity, etc.), as well as the configuration options used to generate the model. In some implementations, the user interface may also show ROC curves and reliability curves for a selected model, as illustrated. Because the models are trained and scored separately (and prior to use of the user interface for selecting a model, in some implementations), the user interface may be very fast and efficient to display, allowing the user to click around and explore and compare various models, as well as sorting the model score list for other desired characteristics. In some implementations, a user may test a model from the interface by providing specific input values as shown in FIG. 41, and having the system apply the selected model configuration to a machine learning system with the input values as input data. As shown in FIG. 4J, the system may provide a classification for the input data, based on the selected model.

Once a model is selected, the system may generate an application (e.g. web application, standalone application, etc.) for the selected model, using the configuration associated with the model. FIG. 5 is a screenshot of an implementation of an automatically generated machine learning application 500 for a selected model. As shown, the application 500 may comprise an input interface 502 (e.g. sliders, text or numerical entry, or any other such interface);

In some implementations, variations of the model may be included with the application and selectable, e.g. via input selection 504 showing types of models available for user. In some implementations, each variation may have its own associated hyperparameters, feature selections, etc. For example, a user may select a plurality of models from which to generate an application using the interface of FIGS. 4A-4J; and when using the application, users may select from the included models via element 504.

The application may also include a display of input values 506 for the selected feature set; and may provide a classification 510. In some implementations, conditions for the classification may be included as part of the model and shown in interface 508, such as a threshold for a probability outcome value to be associated with a particular outcome.

Thus, according to the systems and methods discussed herein, a huge number of machine learning models may be automatically generated and tested, with the results compared to select a model and feature set having a highest desired characteristic (e.g. sensitivity, accuracy, etc.). In some implementations, a web application may be automatically generated from the selected model and feature set, allowing for machine learning to be efficiently and easily used by users with no coding, data science, or artificial intelligence experience or knowledge.

In one aspect, the present disclosure is directed to a method for automatic generation of machine learning applications. The method includes receiving, by a computing device, input data. The method also includes identifying, by the computing device, a plurality of feature sets by determining correlations or covariances between combinations of features in the input data. The method also includes generating, by the computing device, a plurality of hyperparameter sets. The method also includes generating, by the computing device, a plurality of machine learning models, each machine learning model utilizing one of the plurality of feature sets and one of the plurality of hyperparameter sets. The method also includes training, by the computing device, each of the plurality of machine learning models using a first subset of the input data. The method also includes scoring, by the computing device, each of the plurality of machine learning models using a second subset of the input data. The method also includes receiving a selection, by the computing device, of a first machine learning model of the scored plurality of machine learning models. The method also includes generating an application, by the computing device, the application executing the first machine learning model.

In some implementations, the method includes scaling the input data to a predetermined range. In a further implementation, the input data comprises a plurality of feature types, and the method further includes scaling input data of each feature type of the plurality of feature types to a predetermined range associated with the corresponding feature type.

In some implementations, the method includes splitting, by the computing device, the input data into the first subset of data and the second subset of data. In a further implementation, the first subset of data is balanced for a first feature of the features in the input data. In some implementations, the method includes generating, via one of a custom grid search or a random search tool, the plurality of hyperparameter sets, each set of hyperparameters distinct from each other set of hyperparameters. In a further implementation, the method includes generating a plurality of values for each hyperparameter, the plurality of values distributed across a predetermined range; and selecting a value for each hyperparameter of a corresponding machine learning model from the generated plurality of values.

In some implementations, the plurality of machine learning models comprise at least one machine learning model of a first type and at least one machine learning model of a different second type. In a further implementation, the first type and second type comprise different ones of a decision tree, a gradient boosting machine, a k-nearest neighbor algorithm, a support vector machine, a random forest algorithm, and a neural network.

In another aspect, the present disclosure is directed to a system for automatic generation of machine learning applications. The system includes a computing device comprising a memory storing input data. The processor is configured to: identify a plurality of feature sets by determining correlations or covariances between combinations of features in the input data; generate a plurality of hyperparameter sets; generate a plurality of machine learning models, each machine learning model utilizing one of the plurality of feature sets and one of the plurality of hyperparameter sets; train each of the plurality of machine learning models using a first subset of the input data; score each of the plurality of machine learning models using a second subset of the input data; receive a selection of a first machine learning model of the scored plurality of machine learning models; and generate an application, the application executing the first machine learning model.

In some implementations, the processor is further configured to scale the input data to a predetermined range. In a further implementation, the input data comprises a plurality of feature types, and the processor is further configured to scale input data of each feature type of the plurality of feature types to a predetermined range associated with the corresponding feature type.

In some implementations, the processor is further configured to split the input data into the first subset of data and the second subset of data. In a further implementation, the first subset of data is balanced for a first feature of the features in the input data.

In some implementations, the processor is further configured to generate, via one of a custom grid search or a random search tool, the plurality of hyperparameter sets, each set of hyperparameters distinct from each other set of hyperparameters. In a further implementation, the processor is further configured to generate a plurality of values for each hyperparameter, the plurality of values distributed across a predetermined range; and select a value for each hyperparameter of a corresponding machine learning model from the generated plurality of values.

In some implementations, the plurality of machine learning models comprise at least one machine learning model of a first type and at least one machine learning model of a different second type. In a further implementation, the first type and second type comprise different ones of a decision tree, a gradient boosting machine, a k-nearest neighbor algorithm, a support vector machine, a random forest algorithm, and a neural network.

In another aspect, the present disclosure is directed to a non-transitory computer readable medium storing instructions that, when executed by a processor of a computing device, cause the computing device to: identify a plurality of feature sets by determining correlations or covariances between combinations of features in a set of received input data; generate a plurality of hyperparameter sets; generate a plurality of machine learning models, each machine learning model utilizing one of the plurality of feature sets and one of the plurality of hyperparameter sets; train each of the plurality of machine learning models using a first subset of the input data; score each of the plurality of machine learning models using a second subset of the input data; receive a selection of a first machine learning model of the scored plurality of machine learning models; and generate an application, the application executing the first machine learning model. In some implementations, the instructions further comprise instructions that cause the computing device to generate, via one of a custom grid search or a random search tool, the plurality of hyperparameter sets, each set of hyperparameters distinct from each other set of hyperparameters.

### B. Computing Environment

Having discussed specific embodiments of the present solution, it may be helpful to describe aspects of the operating environment as well as associated system components (e.g., hardware elements) in connection with the methods and systems described herein.

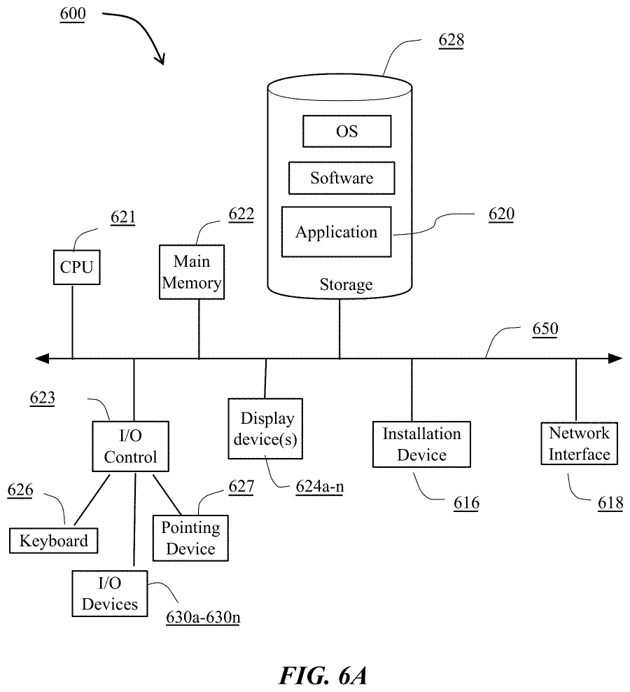

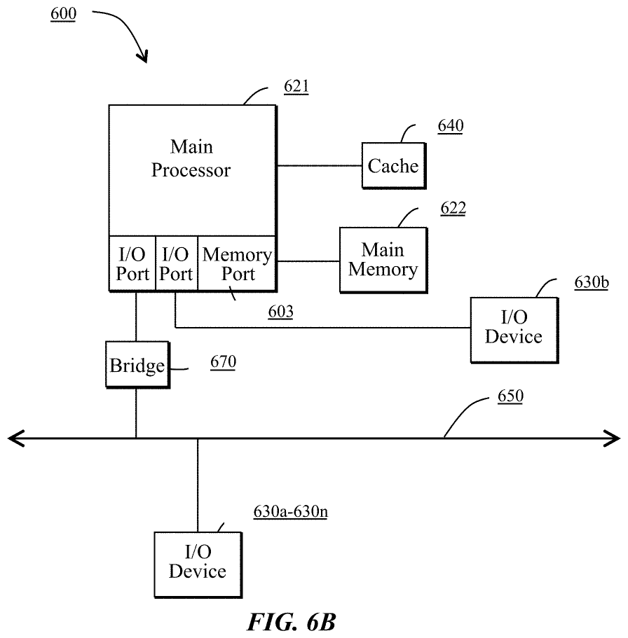

The systems discussed herein may be deployed as and/or executed on any type and form of computing device, such as a computer, network device or appliance capable of communicating on any type and form of network and performing the operations described herein. FIGS. 6A and 6B depict block diagrams of a computing device 600 useful for practicing the operations described herein. As shown in FIGS. 6A and 6B, each computing device 600 includes a central processing unit 621, and a main memory unit 622. As shown in FIG. 6A, a computing device 600 may include a storage device 628, an installation device 616, a network interface 618, an I/O controller 623, display devices 624a-624n, a keyboard 626 and a pointing device 627, such as a mouse. The storage device 628 may include, without limitation, an operating system and/or software. As shown in FIG. 6B, each computing device 600 may also include additional optional elements, such as a memory port 603, a bridge 670, one or more input/output devices 630a-630n (generally referred to using reference numeral 630), and a cache memory 640 in communication with the central processing unit 621.

The central processing unit 621 is any logic circuitry that responds to and processes instructions fetched from the main memory unit 622. In many embodiments, the central processing unit 621 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621, such as any type or variant of Static random access memory (SRAM), Dynamic random access memory (DRAM), Ferroelectric RAM (FRAM), NAND Flash, NOR Flash and Solid State Drives (SSD). The main memory 622 may be based on any of the above described memory chips, or any other available memory chips capable of operating as described herein. In the embodiment shown in FIG. 6A, the processor 621 communicates with main memory 622 via a system bus 650 (described in more detail below). FIG. 6B depicts an embodiment of a computing device 600 in which the processor communicates directly with main memory 622 via a memory port 603. For example, in FIG. 6B the main memory 622 may be DRDRAM.

FIG. 6B depicts an embodiment in which the main processor 621 communicates directly with cache memory 640 via a secondary bus, sometimes referred to as a backside bus. In other embodiments, the main processor 621 communicates with cache memory 640 using the system bus 650. Cache memory 640 typically has a faster response time than main memory 622 and is provided by, for example, SRAM, BSRAM, or EDRAM. In the embodiment shown in FIG. 6B, the processor 621 communicates with various I/O devices 630 via a local system bus 650. Various buses may be used to connect the central processing unit 621 to any of the I/O devices 630, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 624, the processor 621 may use an Advanced Graphics Port (AGP) to communicate with the display 624. FIG. 6B depicts an embodiment of a computer 600 in which the main processor 621 may communicate directly with I/O device 630b, for example via HYPERTRANSPORT, RAPIDIO, or INFINIBAND communications technology. FIG. 6B also depicts an embodiment in which local busses and direct communication are mixed: the processor 621 communicates with I/O device 630a using a local interconnect bus while communicating with I/O device 630b directly.

A wide variety of I/O devices 630a-630n may be present in the computing device 600. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 623 as shown in FIG. 6A. The I/O controller may control one or more I/O devices such as a keyboard 626 and a pointing device 627, e.g., a mouse or optical pen. Furthermore, an I/O device may also provide storage and/or an installation medium 616 for the computing device 600. In still other embodiments, the computing device 600 may provide USB connections (not shown) to receive handheld USB storage devices such as the USB Flash Drive line of devices manufactured by Twintech Industry, Inc. of Los Alamitos, Calif.

Referring again to FIG. 6A, the computing device 600 may support any suitable installation device 616, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 600 may further include a storage device, such as one or more hard disk drives or redundant arrays of independent disks, for storing an operating system and other related software, and for storing application software programs such as any program or software 620 for implementing (e.g., configured and/or designed for) the systems and methods described herein. Optionally, any of the installation devices 616 could also be used as the storage device. Additionally, the operating system and the software can be run from a bootable medium.

Furthermore, the computing device 600 may include a network interface 618 to interface to the network 604 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 600 communicates with other computing devices 600′ via any type and/or form of gateway or tunneling protocol such as Secure Socket Layer (SSL) or Transport Layer Security (TLS). The network interface 618 may include a built-in network adapter, network interface card, PCMCIA network card, card bus network adapter, wireless network adapter, USB network adapter, modem or any other device suitable for interfacing the computing device 600 to any type of network capable of communication and performing the operations described herein.

In some embodiments, the computing device 600 may include or be connected to one or more display devices 624a-624n. As such, any of the I/O devices 630a-630n and/or the I/O controller 623 may include any type and/or form of suitable hardware, software, or combination of hardware and software to support, enable or provide for the connection and use of the display device(s) 624a-624n by the computing device 600. For example, the computing device 600 may include any type and/or form of video adapter, video card, driver, and/or library to interface, communicate, connect or otherwise use the display device(s) 624a-624n. In one embodiment, a video adapter may include multiple connectors to interface to the display device(s) 624a-624n. In other embodiments, the computing device 600 may include multiple video adapters, with each video adapter connected to the display device(s) 624a-624n. In some embodiments, any portion of the operating system of the computing device 600 may be configured for using multiple displays 624a-624n. One ordinarily skilled in the art will recognize and appreciate the various ways and embodiments that a computing device 600 may be configured to have one or more display devices 624a-624n.

In further embodiments, an I/O device 630 may be a bridge between the system bus 650 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 600 of the sort depicted in FIGS. 6A and 6B may operate under the control of an operating system, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 600 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 600 has sufficient processor power and memory capacity to perform the operations described herein.

In some embodiments, the computing device 600 may have different processors, operating systems, and input devices consistent with the device. For example, in one embodiment, the computing device 600 is a smart phone, mobile device, tablet or personal digital assistant. In still other embodiments, the computing device 600 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 600 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices, for example, consistent with the terms “user” and “multi-user” typically used in the context of a multi-user multiple-input and multiple-output (MU-MIMO) environment.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for automatic generation of machine learning applications, comprising:
receiving, by a computing device, input data;
identifying, by the computing device, a plurality of feature sets by determining correlations or covariances between combinations of features in the input data;
generating, by the computing device, a plurality of hyperparameter sets;
generating, by the computing device, a plurality of machine learning models, each machine learning model utilizing one of the plurality of feature sets and one of the plurality of hyperparameter sets;
training, by the computing device, each of the plurality of machine learning models using a first subset of the input data;
scoring, by the computing device, each of the plurality of machine learning models using a second subset of the input data;
receiving a selection, by the computing device, of a first machine learning model of the scored plurality of machine learning models; and
generating an application, by the computing device, the application executing the first machine learning model.

2. The method of claim 1, further comprising scaling the input data to a predetermined range.

3. The method of claim 2, wherein the input data comprises a plurality of feature types, and wherein scaling the input data further comprises scaling input data of each feature type of the plurality of feature types to a predetermined range associated with the corresponding feature type.

4. The method of claim 1, further comprising splitting, by the computing device, the input data into the first subset of data and the second subset of data.

5. The method of claim 4, wherein the first subset of data is balanced for a first feature of the features in the input data.

6. The method of claim 1, wherein generating the plurality of hyperparameter sets further comprises generating, via one of a custom grid search or a random search tool, the plurality of hyperparameter sets, each set of hyperparameters distinct from each other set of hyperparameters.

7. The method of claim 6, wherein generating the plurality of hyperparameter sets further comprises generating a plurality of values for each hyperparameter, the plurality of values distributed across a predetermined range; and selecting a value for each hyperparameter of a corresponding machine learning model from the generated plurality of values.

8. The method of claim 1, wherein the plurality of machine learning models comprise at least one machine learning model of a first type and at least one machine learning model of a different second type.

9. The method of claim 8, wherein the first type and second type comprise different ones of a decision tree, a gradient boosting machine, a k-nearest neighbor algorithm, a support vector machine, a random forest algorithm, and a neural network.

10. A system for automatic generation of machine learning applications, comprising:
a computing device comprising a memory storing input data, and a processor configured to:
identify a plurality of feature sets by determining correlations or covariances between combinations of features in the input data,
generate a plurality of hyperparameter sets,
generate a plurality of machine learning models, each machine learning model utilizing one of the plurality of feature sets and one of the plurality of hyperparameter sets,
train each of the plurality of machine learning models using a first subset of the input data,
score each of the plurality of machine learning models using a second subset of the input data,
receive a selection of a first machine learning model of the scored plurality of machine learning models, and
generate an application, the application executing the first machine learning model.

11. The system of claim 10, wherein the processor is further configured to scale the input data to a predetermined range.

12. The system of claim 11, wherein the input data comprises a plurality of feature types, and wherein the processor is further configured to scale input data of each feature type of the plurality of feature types to a predetermined range associated with the corresponding feature type.

13. The system of claim 10, wherein the processor is further configured to split the input data into the first subset of data and the second subset of data.

14. The system of claim 13, wherein the first subset of data is balanced for a first feature of the features in the input data.

15. The system of claim 10, wherein the processor is further configured to generate, via one of a custom grid search or a random search tool, the plurality of hyperparameter sets, each set of hyperparameters distinct from each other set of hyperparameters.

16. The system of claim 15, wherein the processor is further configured to generate a plurality of values for each hyperparameter, the plurality of values distributed across a predetermined range; and select a value for each hyperparameter of a corresponding machine learning model from the generated plurality of values.

17. The system of claim 10, wherein the plurality of machine learning models comprise at least one machine learning model of a first type and at least one machine learning model of a different second type.

18. The system of claim 17, wherein the first type and second type comprise different ones of a decision tree, a gradient boosting machine, a k-nearest neighbor algorithm, a support vector machine, a random forest algorithm, and a neural network.

19. A non-transitory computer readable medium storing instructions that, when executed by a processor of a computing device, cause the computing device to:
identify a plurality of feature sets by determining correlations or covariances between combinations of features in a set of received input data;
generate a plurality of hyperparameter sets;
generate a plurality of machine learning models, each machine learning model utilizing one of the plurality of feature sets and one of the plurality of hyperparameter sets;
train each of the plurality of machine learning models using a first subset of the input data;
score each of the plurality of machine learning models using a second subset of the input data;
receive a selection of a first machine learning model of the scored plurality of machine learning models; and
generate an application, the application executing the first machine learning model.

20. The computer readable medium of claim 19, wherein the instructions further comprise instructions that cause the computing device to generate, via one of a custom grid search or a random search tool, the plurality of hyperparameter sets, each set of hyperparameters distinct from each other set of hyperparameters.
